(19) United States
(12) Patent Application Publication
(10) Pub. No.: US 2025/0038388 A1
(43) Pub. Date: Jan. 30, 2025

(54) TRANSMISSION LINE

(71) Applicant: FUJIKURA LTD., Tokyo (JP)

(72) Inventor: Yusuke Uemichi, Sakura-shi (JP)

(73) Assignee: FUJIKURA LTD., Tokyo (JP)

(21) Appl. No.: 18/717,132

(22) PCT Filed: Jul. 29, 2022
(86) PCT No.: PCT/JP2022/029297

§ 371 Date: Jun. 6, 2024

(30) Foreign Application Priority Data
Dec. 21, 2021 (JP) 2021-207428

(51) Int. Cl. H01P 3/00

(52) U.S. Cl. CPC H01P 3/006

(57) ABSTRACT

To reduce return loss in a transmission line that transmits a high-frequency wave between a pair of main surfaces of a substrate, as compared with the input/output structure included in the filter device disclosed in Patent Literature 1. The transmission line (1) includes: a substrate (10); a coplanar line (20) including a signal line pattern (21) provided on a main surface (11) and a first coplanar pattern (coplanar patterns 22 and 23) provided on the main surface (11); and a two-conductor line (30) including a first through via (31) electrically connected with the signal line pattern (21) and a ground conductor (through vias 32 and 33).

### TECHNICAL FIELD

The present invention relates to a transmission line.

### BACKGROUND ART

FIGS. 1 to 4 of Patent Literature 1 disclose a filter device in which two microstrip lines electromagnetically coupled to each other are used. This filter device includes a substrate made of a dielectric, a pair of signal lines provided on a first main surface of the substrate (in Patent Literature 1, referred to as “stubs 6a and 6b” and “patches 8a and 8b”), a ground conductor provided on a second main surface of the substrate (in Patent Literature 1, referred to as “ground conductor surface 10”), and a pair of input/output structures (in Patent Literature 1, referred to as “input and output taps 14a and 14b” and “metallized holes”). The stubs 6a and 6b are conductor patterns each having a strip shape. The input and output taps 14a and 14b are conductor patterns provided so as to protrude from midway points of the stubs 6a and 6b, respectively.

In a case where this filter device is mounted on a mounting substrate, the second main surface (the main surface opposite to the main surface on which a signal line is provided) of the substrate of the filter device is typically caused to face a first main surface of the mounting substrate. Therefore, a through via (in Patent Literature 1, referred to as “metallized hole”) passing through the pair of main surfaces of the substrate is provided in the vicinity of each of end portions opposite to those which are connected to the stubs 6a and 6b, among the end portions of the input and output taps 14a and 14b. The through via being connected to each of the input and output taps 14a and 14b enables supply of a high-frequency wave from the second main surface side of the substrate of the filter device to the filter device.

### CITATION LIST

### Patent Literature

[Patent Literature 1]
Specification of U.S. Pat. No. 5,343,176

### SUMMARY OF INVENTION

### Technical Problem

However, in such an input/output structure, when the high-frequency wave to be transmitted has a higher frequency, it is more likely to increase return loss. This is because in the input/output structure, the one through via, which is not enough to serve as a transmission line, serves to transmit a high-frequency wave between the pair of main surfaces of the substrate.

An aspect of the present invention has been achieved in light of the foregoing problem. It is an object of the aspect of the present invention to, in a transmission line that transmits a high-frequency wave between a pair of main surfaces of a substrate, reduce return loss, as compared with the input/output structure included in the filter device disclosed in Patent Literature 1.

### Solution to Problem

In order to solve the foregoing problem, a transmission line in accordance with Aspect 1 of the present invention includes: (i) a substrate made of a dielectric; (ii) a first coplanar line provided on the substrate, the first coplanar line including: a first signal line pattern which is provided on a first main surface of the substrate; and a first coplanar pattern by which the first signal line pattern is held; and (iii) a two-conductor line provided on the substrate, the two-conductor line including: a first through via that is electrically connected with the first signal line pattern and that passes through the substrate from the first main surface to a second main surface of the substrate; and a ground conductor.

### Advantageous Effects of Invention

According to an aspect of the present invention, it is possible to, in a transmission line that transmits a high-frequency wave between a pair of main surfaces of a substrate, reduce return loss, as compared with the input/output structure included in the filter device disclosed in Patent Literature 1.

### BRIEF DESCRIPTION OF DRAWINGS

FIG. 1 is a perspective view illustrating a transmission line in accordance with an embodiment of the present invention.
(a) to (c) of FIG. 2 are respectively a bottom view, a plan view, and a rear view of the transmission line illustrated in FIG. 1.

FIG. 3 is a cross-sectional view illustrating the transmission line illustrated in FIG. 1. (a) is a cross-sectional view taken along A-A′ line in (a) of FIG. 1 and a z axis, and (b) is a cross-sectional view taken along B-B′ line in (a) of FIG. 1 and the z axis.
(a) of FIG. 4 is a rear view illustrating a first variation of the transmission line illustrated in FIG. 1, and (b) of FIG. 4 is a bottom view illustrating the first variation.

FIG. 5 is a bottom view of a second variation of the transmission line illustrated in FIG. 1.

FIG. 6 is a bottom view of a third variation of the transmission line illustrated in FIG. 1.

### DESCRIPTION OF EMBODIMENTS

### [Transmission Line]

### <Outline>

With reference to FIG. 1 to FIG. 3, the following description will discuss a transmission line 1 in accordance with an embodiment of the present invention. FIG. 1 is a perspective view illustrating the transmission line 1. In FIG. 2, (a) to (c) are respectively a bottom view, a plan view, and a rear view of the transmission line illustrated in FIG. 1. FIG. 3 is a cross-sectional view illustrating the transmission line 1. In FIG. 3, (a) is a cross-sectional view taken along A-A′ line in (a) of FIG. 1 and a z axis, and (b) is a cross sectional view taken along B-B′ line in (a) of FIG. 1 and the z axis.

The transmission line 1 can be suitably used as an input/output structure for a filter device typified by, for example, the filter device disclosed in Patent Literature 1 and a filter device disclosed in PCT International Publication No. PCT/JP2021/011615. In a case where the transmission line 1 is used as an input/output structure for such a filter device, the filter device is provided on a single substrate together with the transmission line 1.

The present embodiment assumes that the filter device is mounted on a first main surface of a mounting substrate so that a second main surface of a substrate of the filter device and the first main surface of the mounting substrate closely face each other. In this case, in the filter device, a conductor pattern for achieving a filtering function is provided on a main surface on a side farther from the mounting substrate among the pair of the main surfaces of the substrate. It is assumed that the transmission line 1 supplies a high-frequency wave to the filter device, from a main surface on a side closer to the mounting substrate, among the pair of main surfaces of the substrate.

Note that the present embodiment employs a 60-GHz center frequency of a transmission band of the filter device. However, the center frequency of the transmission band of the filter device is not limited to 60 GHz and can be determined as appropriate, for example, in a band of not less than 30 GHz and not more than 75 GHz. The structure of the transmission line 1 and sizes of the components of the transmission line 1 are optimized so as to reduce loss at the center frequency of the transmission band of the filter device as much as possible.

### <Configuration>

As illustrated in FIG. 1, the transmission line 1 includes a substrate 10, a coplanar line 20, a two-conductor line 30, and a coplanar line 40. Each of the coplanar line 20, the two-conductor line 30, and the coplanar line 40 is provided on the substrate 10. In the present specification, the “two-conductor line” refers to a high-frequency-wave transmission line including two conductors with different functions: a conductor constituting a signal line and a conductor constituting a ground. In the present specification, the ground of the two-conductor line may be constituted by a single conductor or may be constituted by a plurality of conductors. Each of a grounded coplanar line, a coplanar line, and a microstrip line is an example of the two-conductor line. Note that the two-conductor line 30 is different from a typical grounded coplanar line, coplanar line, and microstrip line and is a high-frequency-wave transmission line that transmits a high-frequency wave in a thickness direction of the substrate 10. Therefore, the two-conductor line 30 is referred to as “two-conductor line”.

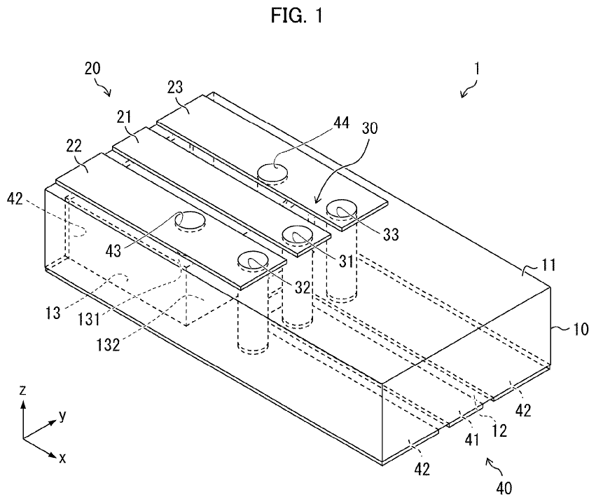

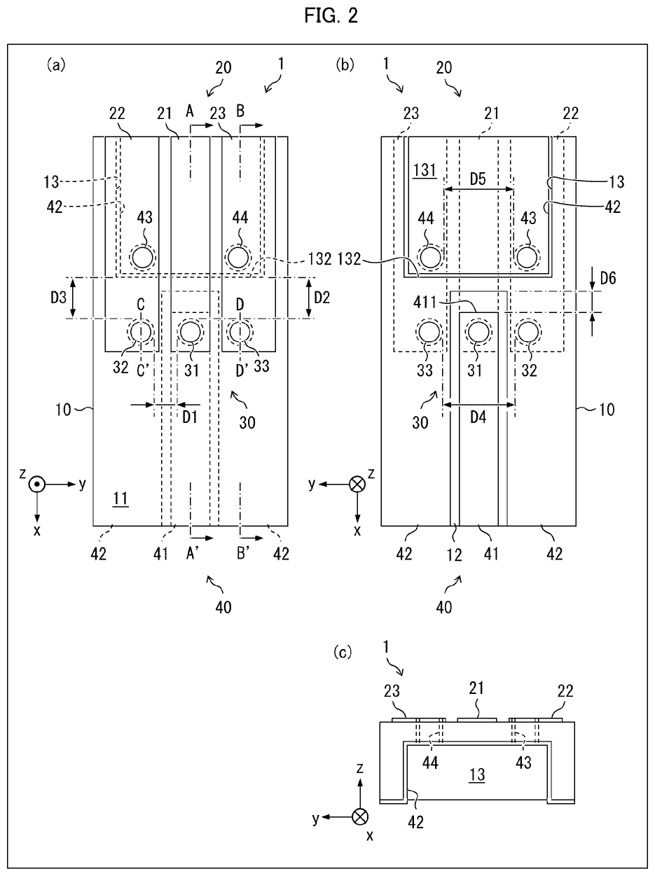

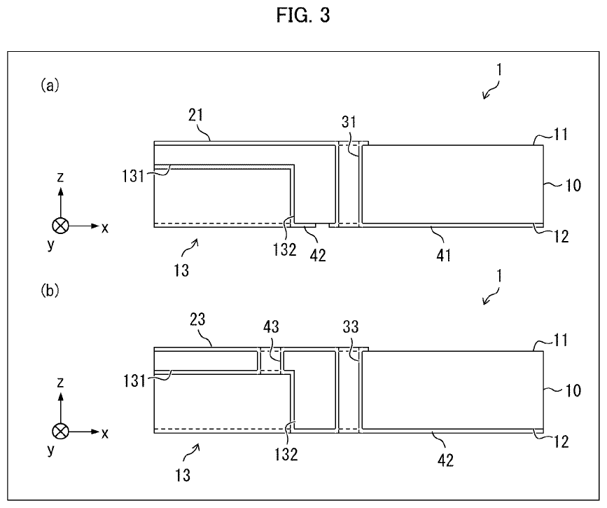

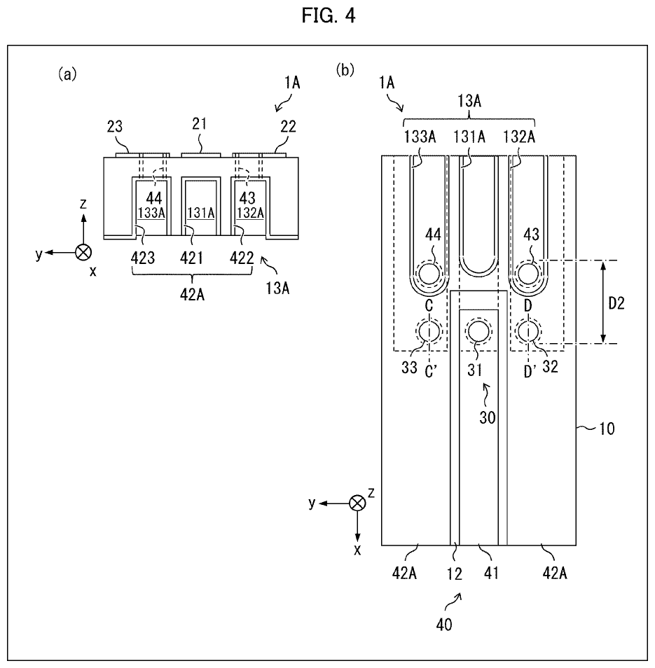

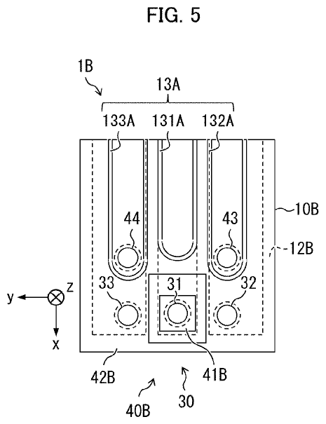

In an aspect of the present invention, like a second variation of the transmission line 1 which will be described later with reference to FIG. 5, it is possible to use a conductor patch 41B instead of a signal line pattern 41 included in the coplanar line 40 of the transmission line 1. That is, in an aspect of the present invention, it is possible to omit the coplanar line 40. Note that FIG. 1 selectively illustrates only characteristic components of the transmission line 1. The substrate 10 is extended in both an x-axis direction and a y-axis direction in the coordinate system illustrated in FIG. 1. In addition, the coplanar line 20 is not limited to the range illustrated in FIG. 1. The end portion of the coplanar line 20 opposite to the end portion connected to the two-conductor line 30 is extended in a negative x-axis direction. Further, the coplanar line 40 is not limited to the range illustrated in FIG. 1. The end portion of the coplanar line 40 opposite to the end portion connected to the two-conductor line 30 is extended in a positive x-axis direction. Note that in an area lying outside the range illustrated in FIG. 1 and on a negative x-axis direction side, the coplanar line 20 (grounded coplanar line) may be connected with a coplanar line. That is, the length along the x-axis direction of a recess 13 described later may be shorter than each of the lengths in the x-axis direction of the signal line pattern 21 and the coplanar patterns 22 and 23 described later. In addition, on the substrate 10, a filter device may be provided, as described above.

### (Substrate)

The substrate 10 is a board member made of a dielectric. In the present embodiment, the dielectric constituting the substrate 10 is quartz glass. However, the dielectric constituting the substrate 10 is not limited to the quartz glass and can be selected as appropriate. Examples of a dielectric other than glass typified by the quartz glass include semiconductors with high resistances and resins. The semiconductors with high resistances may be a compound semiconductor typified by gallium arsenide (GaAs) or may be silicon. Examples of the resins include a fluororesin. The dielectric constituting the substrate 10 may be a fluorine compound.

In the present embodiment, the substrate 10 has a thickness of 400 μm. Note, however, that the thickness of the substrate 10 is not limited to 400 μm and can be determined as appropriate.

Among a pair of main surfaces 11 and 12 of the substrate 10, the main surface 11 is an upper main surface in the state illustrated in FIG. 1 and the main surface 12 is a lower main surface in the state illustrated in FIG. 1.

In the coordinate system illustrated in FIG. 1, a positive z-axis direction is a direction normal to the main surfaces 11 and 12 from the main surface 12 toward the main surface 11; a positive x-axis direction is a direction in which a signal line pattern 21 of the coplanar line 20 described later is extended toward a two-conductor line 30 described later; and a positive y-axis direction is a direction constituting a right-handed orthogonal coordinate system together with the positive x-axis direction and the positive z-axis direction.

The main surface 12 of the substrate 10 is provided with a recess 13 formed in an area of the main surface 12 which area overlaps at least part of the signal line pattern 21 described later. In the present embodiment, the recess 13 is configured to overlap part of each coplanar patterns 22 and 23 as well as part of the signal line pattern 21 (see (a) and (b) of FIG. 2).

The recess 13 is constituted by a bottom surface 131 parallel to the main surfaces 11 and 12; and side surfaces perpendicular to the bottom surface 131. Hereinafter, among the side surfaces, the side surface close to the two-conductor line 30 described later is referred to as “side surface 132”.

### (First Coplanar Line)

The coplanar line 20 is a two-conductor line provided on the substrate 10, as illustrated in FIG. 1, (a) of FIG. 2, and (a) of FIG. 3. The coplanar line 20 includes the signal line pattern 21 and the coplanar patterns 22 and 23.

The signal line pattern 21 and the coplanar patterns 22 and 23 are provided on the main surface 11 of the substrate 10. The signal line pattern 21 is an example of a first signal line pattern. The coplanar patterns 22 and 23 are an example of a first coplanar pattern.

The signal line pattern 21 functions as a signal line of the coplanar line 20.

The coplanar patterns 22 and 23 are provided such that the signal line pattern 21 is held thereby (sandwiched therebetween).

A ground conductor pattern 42 is a conductor pattern provided so as to cover part of the main surface 12 and the surface of the recess 13 (the bottom surface 131 and the side surfaces) (see (b) of FIG. 2 and (a) of FIG. 3).

The signal line pattern 21 together with the substrate 10 and the coplanar patterns 22 and 23 constitutes a coplanar line. Further, in an area that overlaps the recess 13 when the main surface 12 is seen in plan view from the negative z-axis direction side, a grounded coplanar line is constituted by the signal line pattern 21 together with the substrate 10, the coplanar patterns 22 and 23, and a part of the ground conductor pattern 42 which part is provided on the bottom surface 131 of the recess 13. Note that hereinafter, the expression “see in plan view” means either seeing the main surface 11 in plan view from a positive z-axis direction side or seeing the main surface 12 in plan view from a negative z-axis direction side.

The signal line pattern 21 and the coplanar patterns 22 and 23 are each a thin film made of a conductor. The present embodiment employs copper as a conductor constituting each of the signal line pattern 21 and the coplanar patterns 22 and 23.

Similarly, the ground conductor pattern 42 and the signal line pattern 41 described later are each a thin film made of a conductor. The present embodiment employs copper as a conductor constituting each of the signal line pattern 41 and the ground conductor pattern 42.

However, the conductor constituting each of the signal line pattern 21, the coplanar patterns 22 and 23, the signal line pattern 41, and the ground conductor pattern 42 is not limited to the copper and can be selected as appropriate.

The signal line pattern 21 and the coplanar patterns 22 and 23 are each obtained by forming a conductor film (in the present embodiment, a film made of copper) that covers the main surface 11 and subjecting the conductor film to patterning into a desired shape. The signal line pattern 41 and the ground conductor pattern 42 are each obtained by, after the recess 13 has been formed in the main surface 12, forming a conductor film (in the present embodiment, a film made of copper) that covers the main surface 12 and the surface of the recess 13 and subjecting the conductor film to patterning into a desired shape. Note that between the signal line pattern 41 and the ground conductor pattern 42, an area from which the conductor film is removed is provided. Therefore, the signal line pattern 41 and the ground conductor pattern 42 are insulated from each other.

In the coplanar line 20, the coplanar pattern 22 and a part of the ground conductor pattern 42 which part is provided on the bottom surface 131 of the recess 13 are short-circuited by a through via 43, and the coplanar pattern 23 and the part of the ground conductor pattern 42 which part is provided on the bottom surface 131 of the recess 13 are short-circuited by a through via 44. The through vias 43 and 44 are an example of a pair of third through vias.

The through vias 43 and 44 are each obtained by forming a conductor film (in the present embodiment, a film made of copper) on an inner wall of a through hole passing through the substrate 10 from the main surface 11 to the bottom surface 131. Therefore, the through vias 43 and 44 are cylindrical members each made of a conductor.

Note, however, that the through vias 43 and 44 can be each obtained also by filling the through hole with a conductor. In this case, the through vias 43 and 44 are columnar members each made of a conductor.

The bottom surface 131 is substantially flat (is flat in the present embodiment), as illustrated in (c) of FIG. 2 and (a) and (b) of FIG. 3.

As illustrated in (b) of FIG. 2, when the main surface 12 is seen in plan view, areas in which the through vias 43 and 44 are provided are included in an area in which the recess 13 is provided. More specifically the through vias 43 and 44 are provided, when the main surface 12 is seen in plan view, in areas that are included in the respective coplanar patterns 22 and 23 and that are close to the signal line pattern 21 (in other words, areas on a signal line pattern 21 side). Therefore, the through vias 43 and 44 short-circuit the coplanar patterns 22 and 23 and the part of the ground conductor pattern 42 which part is provided on the bottom surface 131 of the recess 13. Further, the through vias 43 and 44 are provided such that the signal line pattern 21 is held thereby.

### (Two-Conductor Line)

As illustrated in FIG. 1, the two-conductor line 30 includes a through via 31 and through vias 32 and 33. The through via 31 is an example of a first through via. The through vias 32 and 33 are an example of a ground conductor and are also an example of one or more second through vias.

The through via 31 and the through vias 32 and 33 are each obtained by forming a conductor film (in the present embodiment, a film made of copper) on an inner wall of a through hole passing through the substrate 10 from the main surface 11 to the main surface 12. Therefore, the through via 31 and the through vias 32 and 33 are cylindrical members each made of a conductor.

Note, however, that the through via 31 and the through vias 32 and 33 can be each obtained also by filling the through hole with a conductor. In this case, the through via 31 and the through vias 32 and 33 are columnar members each made of a conductor.

In the present embodiment, the two through vias 32 and 33 are used as an example of one or more second through vias. However, one of the through vias 32 and 33 may be omitted, or alternatively, the second through vias can be three or more through vias. Note that, in order to increase a symmetric property of a distribution of a capacitance that occurs between the through via 31 and the second through vias, it is preferable that the second through vias be disposed so as to have a symmetric property as great as possible.

### (Second Coplanar Line)

The coplanar line 40 is provided on the main surface 12, as illustrated in (b) of FIG. 2. The coplanar line 40 includes the signal line pattern 41 and a second coplanar pattern constituted by part of the ground conductor pattern 42.

The signal line pattern 41 is an example of a second signal line pattern. In the signal line pattern 41, the vicinity of an end portion 411, which is one end of the signal line pattern 41, is electrically connected with the through via 31. The signal line pattern 41 is substantially parallel (in the present embodiment, is parallel) to the signal line pattern 21 and is extended in a direction away from the signal line pattern 21 (in the positive x-axis direction in (a) and (b) of FIG. 2).

The ground conductor pattern 42 is provided so as to surround the long sides of the signal line pattern 41 (the sides along the x-axis direction in the coordinate system illustrated in FIG. 2) and the end portion 411 of the signal line pattern 41 from three directions. As described above, the ground conductor pattern 42 is a conductor pattern provided so as to cover part of the main surface 12 and the surface of the recess 13 (the bottom surface 131 and the side surfaces) (see (b) of FIG. 2 and (a) of FIG. 3). The ground conductor pattern 42 has a pattern that surrounds the signal line pattern 41 from the three directions as well as causes the signal line pattern 41 to be held thereby. Part of the ground conductor pattern 42 configured in such a way is an example of the second coplanar pattern.

The transmission line 1 is configured such that an interval D6 between the signal line pattern 41 and the ground conductor pattern 42 becomes widest at the end portion 411. That is, the interval D6 at the long sides of the signal line pattern 41 is smaller than the interval D6 at the end portion 411. Note that (b) of FIG. 2 illustrates the interval D6 at the end portion 411.

Note that the same description in the section concerning the coplanar line 20 applies to a conductor film constituting the signal line pattern 41 and a conductor film constituting the ground conductor pattern 42, and thus the descriptions thereof are omitted here.

### (Arrangement of Through Vias and Recess)

A configuration is employed in which in the transmission line 1, a distance D1 which is the shortest distance between the through via 31 and the through via 32 is shorter than a distance D2 which is the shortest distance between the through via 31 and the recess 13, as illustrated in (a) of FIG. 2. The distance D2 is an interval between the through via 31 and the side surface 132 of the recess 13 when the main surface 12 is seen in plan view from the negative z-axis direction side. Note that the transmission line 1 is configured to be in reflection symmetry with a plane along A-A′ line in (a) of FIG. 2 and the z axis as a symmetry plane. Therefore, in the transmission line 1, the shortest distance between the through via 31 and the through via 33 is equal to the distance D1 and is shorter than the distance D2.

Further, a configuration is employed in which in the transmission line 1, a distance D4 which is the shortest distance between the through vias 32 and 33 is different from a distance D5 which is the shortest distance between the through vias 43 and 44, as illustrated in (b) of FIG. 2. In the transmission line 1 illustrated in (b) of FIG. 2, the distance D4 is slightly wider than the distance D5.

Furthermore, a configuration is employed in which in the transmission line 1, when the main surface 11 is seen in plan view, the distance D2 which is the shortest distance between the through via 31 and the recess 13 is equal to a distance D3 which is the shortest distance between each through vias 32 and 33 and the recess 13, as illustrated in (a) of FIG. 2. Note, however, that the distance D2 and the distance D3 may differ from each other. Moving the center of the through via 32 along the C-C′ line in (a) of FIG. 2 which is parallel to the x-axis direction makes it possible to change the distance D1. The distance D1 is one of design parameters to match the impedance of the coplanar line 20 and the impedance of the two-conductor line 30. When the impedance of the coplanar line 20 and the impedance of the two-conductor line 30 are matched using the distance D1 as a design parameter, the distance D2 and the distance D3 differ from each other in many cases. Similarly, moving the center of the through via 33 along D-D′ line in (a) of FIG. 2 makes it possible to change the shortest distance between the through via 31 and the through via 33.

### First Variation

With reference to FIG. 4, the following description will discuss a transmission line 1A which is a first variation of the transmission line 1. In FIG. 4, (a) is a rear view of the transmission line 1A and (b) is a bottom view of the transmission line 1A. For convenience of description, a member having a function identical to that of a member discussed in the section concerning the transmission line 1 is given an identical reference sign, and a description thereof is omitted.

In the transmission line 1 illustrated in (b) and (c) of FIG. 2, the single recess 13 is formed in an area overlapping part of the signal line pattern 21 and part of each coplanar patterns 22 and 23.

On the other hand, in the transmission line 1A, a recess group 13A constituted by three recesses 131A, 132A, and 133A is provided in an area of the main surface 12 which area overlaps at least the signal line pattern 21, as illustrated in (a) and (b) of FIG. 4. The recesses 131A, 132A, and 133A are provided in areas overlapping a part of the signal line pattern 21, a part of the coplanar pattern 22, and a part of the coplanar pattern 23, respectively. Note that in the present variation, a conductor film formed on the main surface 12 and the surface of the recess group 13A is referred to as a “ground conductor pattern 42A”. Further, conductor films formed on the surfaces of the recesses 131A, 132A, and 133A constituting the recess group 13A are referred to as ground conductor patterns 421, 422, and 423, respectively.

As such, in an aspect of the present invention, the recess provided in an area overlapping at least the signal line pattern 21 may be the single recess 13 or may be the recess group 13A constituted by the three recesses divided. Further, the number of the recesses constituting the recess group 13A is not limited to three and can be set as appropriate. For example, the recess group 13A can be formed by using a laser processing machine to irradiate quartz glass with laser light to modify (laser-modify) the quartz glass and etching the modified parts of the quartz glass through wet etching. In this case, the widths and the number of the recesses may be determined depending on a scanning path of the laser light used for the laser processing and the etching time during the wet etching.

In addition, in the transmission line 1A, an end portion of each recess 131A, 132A, and 133A which is on a two-conductor line 30 side is configured to have a semicircular shape when the main surface 12 is seen in plan view. This is because the recess group 13A is formed through the laser modification and the wet etching.

In addition, a configuration is employed in which in the side surface of each recess 131A, 132A, and 133A which is close to the through via 31 and the through vias 32 and 33 in the transmission line 1A, a part close to the through via 31 (specifically, the side surface at the end portion of the recess 131A) recedes further than (is closer to the negative x-axis direction side than) a part close to each of the through vias 32 and 33 (specifically, the side surface at each of the end portions of the recesses 132A and 133A).

Note that in the transmission line 1A, as in the case of the transmission line 1, the two-conductor line 30 is constituted by providing, on both sides of the through via 31, the through vias 32 and 33 by which the through via 31 is held. Instead of providing the through vias 32 and 33, the recesses 132A and 133A, among the recesses constituting the recess group 13A, can be extended in the positive x-axis direction, thereby allowing the through via 31 and the ground conductor pattern 42A that is provided on the side walls of the extended recesses 132A and 133A to constitute the two-conductor line. Note that this configuration can be applied to a transmission line 1B described later.

### Second Variation

With reference to FIG. 5, the following description will discuss a transmission line 1B which is a second variation of the transmission line 1 and is also one variation of the transmission line 1A. FIG. 5 is a bottom view of the transmission line 1B. The transmission line 1B is based on the transmission line 1A illustrated in FIG. 4. For convenience of description, a member having a function identical to that of a member discussed in the sections concerning the transmission line 1 and the transmission line 1A is given an identical reference sign, and a description thereof is omitted.

In comparison with the transmission line 1 and the transmission line 1A, the transmission line 1B employs an input/output terminal 40B instead of the coplanar line 40. In the present variation, the input/output terminal 40B will be described. Note that, as in the case of the substrate 10 included in the transmission line 1, a substrate 10B included in the transmission line 1B is a board member made of quartz glass. In the present variation, the main surface corresponding to the main surface 12 of the substrate 10 is referred to as “main surface 12B”.

In the transmission line 1B, a conductor patch 41B that functions as a signal terminal is provided, when the main surface 12B is seen in plan view, in an area of the main surface 12 which area includes the through via 31 (see FIG. 5). The conductor patch 41B is spaced from the ground conductor pattern 42. The conductor patch 41B is obtained by configuring the signal line pattern 41 illustrated in (c) of FIG. 2 or (b) of FIG. 4 to be short.

Even in a case where, as described above, the conductor patch 41B is provided only in the area which includes the through via 31, use of a technique called “pad on via” enables connection of the input/output terminal 40B to an input/output terminal provided on a first main surface of the mounting substrate.

### Third Variation

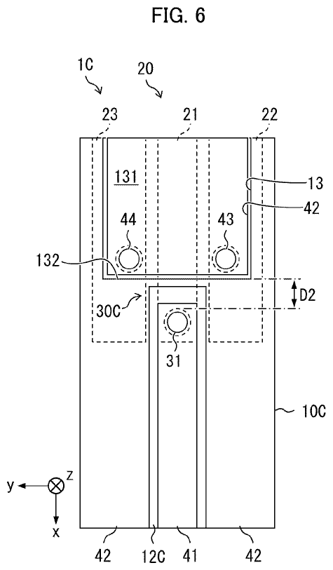

With reference to FIG. 6, the following description will discuss a transmission line 1C which is a third variation of the transmission line 1. FIG. 6 is a bottom view of the transmission line 1C. The transmission line 1C is based on the transmission line 1 illustrated in FIGS. 1 to 3. For convenience of description, a member having a function identical to that of a member discussed in the foregoing embodiments is given an identical reference sign, and a description thereof is omitted.

In comparison with the transmission line 1, in the transmission line 1C, the through vias 32 and 33 are omitted, and the distance D2 between the through via 31 and the side surface 132 of the recess 13 is decreased. In the transmission line 1, the two-conductor line 30 includes the through via 31 and the through vias 32 and 33. On the other hand, in the transmission line 1C, a two-conductor line 30C includes the through via 31 and a conductor film which is a part of the conductor film constituting the ground conductor pattern 42 and which is provided on the side surface 132 of the recess 13. The conductor film provided on the side surface 132 of the recess 13 is an example of a second ground conductor.

As such, the transmission line 1C includes a substrate 10C, the coplanar line 20, the two-conductor line 30C, and the coplanar line 40. Note that, as in the case of the substrate 10 included in the transmission line 1, the substrate 10C included in the transmission line 1C is a board member made of quartz glass. In the present variation, the main surface corresponding to the main surface 12 of the substrate 10 is referred to as “main surface 12C”.

The coplanar line 20 is provided on the substrate 10C. The coplanar line 20 includes (i) the signal line pattern 21 provided on the main surface (the main surface corresponding to the main surface 11 of the transmission line 1) opposite to the main surface 12C and (ii) the coplanar patterns 22 and 23 (one example of the first coplanar pattern) by which the signal line pattern 21 is held.

In the transmission line 1C, the coplanar patterns 22 and 23 are each configured to have a length equal to that of the signal line pattern 21. That is, as in the case of the signal line pattern 21, the tips of the coplanar patterns 22 and 23 are located ahead of the through via 31. Note, however, that in the transmission line 1C, the coplanar patterns 22 and 23 may each have a length shorter than that of the signal line pattern 21. In this case, the tips of the coplanar patterns 22 and 23 are preferably closer to a through via 31 side than the side surface 132 of the recess 13 is.

The two-conductor line 30C is provided to the substrate 10C. The two-conductor line 30C includes the through via 31 that is electrically connected with the signal line pattern 21 and that passes through the substrate 10C from the main surface opposite to the main surface 12C to the main surface 12C; and a second ground conductor.

The recess 13 is provided, when the main surface 12C is seen in plan view, in an area of the main surface 12C which area overlaps at least the signal line pattern 21. In the present variation, the recess 13 is provided also, when the main surface 12C is seen in plan view, in an area that overlaps the coplanar patterns 22 and 23.

In the transmission line 1C, the signal line pattern 21, the coplanar patterns 22 and 23, and a part of the ground conductor pattern 42 which part is provided on the bottom surface 131 of the recess 13 constitute a grounded coplanar line. In the transmission line 1C, the ground conductor is a part of the ground conductor pattern 42 which part is provided on the side surface 132 of the recess 13.

### ADDITIONAL REMARKS

The present invention is not limited to the embodiments, but can be altered by a skilled person in the art within the scope of the claims. The present invention also encompasses, in its technical scope, any embodiment derived by combining technical means disclosed in differing embodiments.

Aspects of the present invention can also be expressed as follows:

A transmission line in accordance with Aspect 1 of the present invention includes: (i) a substrate made of a dielectric; (ii) a first coplanar line provided on the substrate, the first coplanar line including: a first signal line pattern which is provided on a first main surface of the substrate; and a first coplanar pattern by which the first signal line pattern is held; and (iii) a two-conductor line provided on the substrate, the two-conductor line including: a first through via that is electrically connected with the first signal line pattern and that passes through the substrate from the first main surface to a second main surface of the substrate; and a ground conductor.

According to the above configuration, it is possible to use the two-conductor line including the first through via and the ground conductor in order to transmit a high-frequency wave between the pair of main surfaces of the substrate. Therefore, it is possible to reduce return loss, as compared with the input/output structure included in the filter device of Patent Literature 1.

In a transmission line in accordance with Aspect 2 of the present invention, a configuration is employed in which, in addition to the configuration of the transmission line in accordance with Aspect 1, a recess is provided in an area of the second main surface of the substrate which area overlaps at least the first signal line pattern, said transmission line further comprising a ground conductor pattern that is provided on the second main surface of the substrate and on a surface of the recess and that faces the first signal line pattern, wherein the first coplanar line and the ground conductor pattern that is provided on the surface of the recess constitute a grounded coplanar line, the ground conductor is one or more second through vias passing through the substrate from the first main surface to the second main surface, the one or more second through vias short-circuiting the first coplanar pattern and the ground conductor pattern that is provided on the second main surface, and a shortest distance between the first through via and each of the one or more second through vias is shorter than a shortest distance between the first through via and the recess.

According to the above configuration, when the two-conductor line is designed, it is necessary only to mainly consider a capacitance that occurs between the first through via and the one or more second through vias. This is because the capacitance that may occur between the first through via and the ground conductor pattern formed on the surface of the recess is smaller than the capacitance that occurs between the first through via and the one or more second through vias. Therefore, it is possible to easily design the transmission line.

In a transmission line in accordance with Aspect 3 of the present invention, a configuration is employed of, in addition to the configuration of the transmission line in accordance with Aspect 2, further including a pair of third through vias short-circuiting the first coplanar pattern and a part of the ground conductor pattern which part is provided on a bottom surface of the recess, the pair of third through vias being provided such that the first signal line pattern is held thereby.

In a transmission line in accordance with an aspect of the present invention, the coplanar line in which the first signal line pattern and the first coplanar pattern extend parallel to each other is interposed between a grounded coplanar line in which the first signal line pattern and the first coplanar pattern; and the ground conductor pattern extend parallel to each other and the two-conductor line in which the first through via and the one or more second through vias extend parallel to each other. According to the above configuration, it is possible to smoothly switch between the waveguide mode in the grounded coplanar line and the waveguide mode in the coplanar line, since the pair of third through vias can short-circuit the ground conductor pattern and the first coplanar pattern. Therefore, it is possible to further reduce the return loss.

In a transmission line in accordance with Aspect 4 of the present invention, a configuration is employed in which, in addition to the configuration of the transmission line in accordance with Aspect 3, each of the pair of third through vias is provided, when seen in plan view, in an area that is included in the first coplanar pattern and that is close to the first signal line pattern.

In a case where a high-frequency wave is transmitted through the first coplanar line, a current distribution caused by the high-frequency wave likely becomes high in an edge portion in which the first signal line pattern and the first coplanar pattern face each other and are close to each other. According to the above configuration, it is possible to short-circuit the first coplanar pattern and the ground conductor pattern in an area which is included in the first coplanar pattern, which is close to the first signal line pattern, and in which the current distribution is high. Thus, it is possible to cause the current distribution of the first coplanar pattern to be close to the current distribution of each of the pair of third through vias. Therefore, it is possible to enhance continuity of the impedance at a boundary between the grounded coplanar line and the first coplanar line.

In a transmission line in accordance with Aspect 5 of the present invention, a configuration is employed in which, in addition to the configuration of the transmission line in accordance with Aspect 2, the recess is provided, when seen in plan view, in an area of the second main surface of the substrate which area overlaps the first signal line pattern and the first coplanar pattern; the one or more second through vias are a pair of second through vias which are provided such that the first through via is held thereby; and the shortest distance between the first through via and the recess differs from a shortest distance between each of the pair of second through vias and the recess.

In a case were the impedance of the grounded coplanar line and the impedance of the two-conductor line are matched as exactly as possible, it is possible to adjust the shortest distance between the pair of second through vias like Aspect 4 or alternatively to adjust the shortest distance between each of the pair of second through vias and the recess like the present aspect. According to the above configuration, as in the case of Aspect 4, it is possible to enhance the impedance matching between the grounded coplanar line and the two-conductor line, resulting in reduction in the return loss.

In a transmission line in accordance with Aspect 6 of the present invention, a configuration is employed in which, in addition to the configuration of the transmission line in accordance with Aspect 2, the recess is provided, when seen in plan view, in an area of the second main surface of the substrate which area overlaps the first signal line pattern and the first coplanar pattern; the one or more second through vias are a pair of second through vias which are provided such that the first through via is held thereby; and a side surface of the recess which side surface is close to the first through via and the pair of second through vias has a part that is close to the first through via and that recedes further than a part of the side surface which part is close to each of the pair of second through vias.

According to the above configuration, it is possible to decrease the entire length of the transmission line (the length in a direction along the first signal line pattern).

In a transmission line in accordance with Aspect 7 of the present invention, a configuration is employed in which, in addition to the configuration of the transmission line in accordance with Aspect 2, the recess is provided in the area of the second main surface of the substrate which area overlaps at least the first signal line pattern; the ground conductor pattern is provided on the surface of the recess; and the ground conductor is a part of the ground conductor pattern which part is provided on a side surface of the recess, the side surface being close to the first through via.

According to the above configuration, when the two-conductor line is designed, it is necessary only to mainly consider a capacitance that occurs between the first through via and a part provided on the side surface of the recess which side surface is close to the first through via. Therefore, it is possible to easily design the transmission line.

In a transmission line in accordance with Aspect 8 of the present invention, a configuration is employed in which, in addition to the configuration of the transmission line in accordance with any one of Aspects 2 to 7, a conductor patch that functions as a signal terminal and that is spaced from the ground conductor pattern is provided, when seen in plan view, in an area of the second main surface of the substrate which area includes the first through via.

The above configuration eliminates the need for further providing, on the second main surface, a two-conductor line (for example, a coplanar line) for causing the signal line to be electrically connected with the first through via in a case where the transmission line is mounted onto a mounting substrate. Therefore, it is possible to reduce a size of the substrate constituting the transmission line.

In a transmission line in accordance with Aspect 9 of the present invention, a configuration is employed of, in addition to the configuration of the transmission line in accordance with any one of Aspects 2 to 7, further including a second coplanar line provided on the second main surface, the second coplanar line including: a second signal line pattern which is electrically connected with the first through via; and a second coplanar pattern by which the second signal line pattern is held.

According to the above configuration, it is possible to reduce the return loss that may occur in a case where the second signal line pattern electrically connected with the first through via is provided on the second main surface.

In a transmission line in accordance with Aspect 10 of the present invention, a configuration is employed in which, in addition to the configuration of the transmission line in accordance with Aspect 9, the second signal line pattern of the second coplanar line is substantially parallel to the first signal line pattern of the first coplanar line and extends in a direction away from the first signal line pattern of the first coplanar line; the second coplanar pattern surrounds the second signal line pattern of the second coplanar line from at least three directions; and an interval between the second signal line pattern of the second coplanar line and the second coplanar pattern of the second coplanar line is widest at an end portion of the second signal line pattern of the second coplanar line which end portion is located on a recess side.

The above configuration makes it easier to match the impedance of the two-conductor line and the impedance of the second coplanar line and thus makes it possible to further reduce return loss.

### REFERENCE SIGNS LIST

1, 1A, 1B, and 1C Transmission line
10, 10B, and 10C Substrate
11 Main surface (first main surface)
12, 12B, and 12C Main surface (second main surface)
13 Recess
131 Bottom surface
132 Side surface
13A Recess group
131A, 132A, and 133A Recess
20 Coplanar line (a part of which constitutes a grounded coplanar line)
21 Signal line pattern
22 and 23 Coplanar pattern (first coplanar pattern)
30 Two-conductor line
31 Through via (first through via)
32 and 33 Through via (second through via, one example of second ground conductor)
40 Coplanar line
41 Signal line pattern
42 Ground conductor pattern (serving also as second coplanar pattern)
43 and 44 Through via (third through via)

1. A transmission line comprising:
(i) a substrate made of a dielectric;
(ii) a first coplanar line provided on the substrate, the first coplanar line including:
a first signal line pattern which is provided on a first main surface of the substrate; and
a first coplanar pattern by which the first signal line pattern is held; and
(iii) a two-conductor line provided on the substrate, the two-conductor line including:
a first through via that is electrically connected with the first signal line pattern and that passes through the substrate from the first main surface to a second main surface of the substrate; and
a ground conductor.

2. The transmission line according to claim 1, wherein
a recess is provided in an area of the second main surface of the substrate which area overlaps at least the first signal line pattern,
said transmission line further comprising a ground conductor pattern that is provided on the second main surface of the substrate and on a surface of the recess and that faces the first signal line pattern, wherein
the first coplanar line and the ground conductor pattern that is provided on the surface of the recess constitute a grounded coplanar line,
the ground conductor is one or more second through vias passing through the substrate from the first main surface to the second main surface, the one or more second through vias short-circuiting the first coplanar pattern and the ground conductor pattern that is provided on the second main surface, and
a shortest distance between the first through via and each of the one or more second through vias is shorter than a shortest distance between the first through via and the recess.

3. The transmission line according to claim 2, further comprising a pair of third through vias short-circuiting the first coplanar pattern and a part of the ground conductor pattern which part is provided on a bottom surface of the recess, the pair of third through vias being provided such that the first signal line pattern is held thereby.

4. The transmission line according to claim 3, wherein each of the pair of third through vias is provided, when seen in plan view, in an area that is included in the first coplanar pattern and that is close to the first signal line pattern.

5. The transmission line according to claim 2, wherein:
the recess is provided, when seen in plan view, in an area of the second main surface of the substrate which area overlaps the first signal line pattern and the first coplanar pattern;
the one or more second through vias are a pair of second through vias which are provided such that the first through via is held thereby; and
the shortest distance between the first through via and the recess differs from a shortest distance between each of the pair of second through vias and the recess.

6. The transmission line according to claim 2, wherein:
the recess is provided, when seen in plan view, in an area of the second main surface of the substrate which area overlaps the first signal line pattern and the first coplanar pattern;
the one or more second through vias are a pair of second through vias which are provided such that the first through via is held thereby; and
a side surface of the recess which side surface is close to the first through via and the pair of second through vias has a part that is close to the first through via and that recedes further than a part of the side surface which part is close to each of the pair of second through vias.

7. The transmission line according to claim 2, wherein:
the recess is provided in the area of the second main surface of the substrate which area overlaps at least the first signal line pattern;
the ground conductor pattern is provided on the surface of the recess; and
the ground conductor is a part of the ground conductor pattern which part is provided on a side surface of the recess, the side surface being close to the first through via.

8. The transmission line according to claim 2, wherein a conductor patch that functions as a signal terminal and that is spaced from the ground conductor pattern is provided, when seen in plan view, in an area of the second main surface of the substrate which area includes the first through via.

9. The transmission line according to claim 2, further comprising a second coplanar line provided on the second main surface, the second coplanar line including:
a second signal line pattern which is electrically connected with the first through via; and
a second coplanar pattern by which the second signal line pattern is held.

10. The transmission line according to claim 9, wherein:
the second signal line pattern of the second coplanar line is substantially parallel to the first signal line pattern of the first coplanar line and extends in a direction away from the first signal line pattern of the first coplanar line;
the second coplanar pattern surrounds the second signal line pattern of the second coplanar line from at least three directions; and
an interval between the second signal line pattern of the second coplanar line and the second coplanar pattern of the second coplanar line is widest at an end portion of the second signal line pattern of the second coplanar line which end portion is located on a recess side.
